(19) United States
(12) Patent Application Publication
(10) Pub. No.: US 2006/0017392 A1
(43) Pub. Date: Jan. 26, 2006

(54) Flat fluorescent lamp improving discharge efficiency

(76) Inventors: Deuk-Il Park, Suwon (KR); Choong-Yop Rhew, Suwon (KR)

Correspondence Address: PARK LAW FIRM, 3255 WILSHIRE BLVD, SUITE 1110, LOS ANGELES, CA, 90010, US

(21) Appl. No.: 11/124,667

(22) Filed: May 9, 2005

(30) Foreign Application Priority Data
Jul. 26, 2004 (KR) 10-2004-0058290

(51) Int. Cl. G09G 3/10

(52) U.S. Cl. 315/169.1

(57) ABSTRACT

The present invention discloses a flat fluorescent lamp which can improve discharge efficiency and luminance by increasing a current density per discharge channel by forming a plurality of independent meandering discharge channels on a rear substrate, lowering a discharge initiation voltage by auxiliary electrodes and internal and external discharge electrodes, and minimizing non-luminescent regions by the external electrodes. A sidewall is installed to form an airtight space between front and rear substrates, cross walls for forming a plurality of independent meandering discharge channels are installed on the rear substrate, and discharge electrodes are disposed at both sides of the starting and terminating ends of the plurality of meandering discharge channels, for discharging the meandering discharge channels in parallel.

### CLAIMING FOREIGN PRIORITY

The applicant claims and requests a foreign priority, through the Paris Convention for the Protection of Industrial Property, based on a patent application filed in the Republic of Korea (South Korea) with the filing date of Jul. 26, 2004, with the patent application number 10-2004-0058290, by the applicant, the contents of which are incorporated by reference into this disclosure as if fully set forth herein.

### TECHNICAL FIELD

The present invention relates to a flat fluorescent lamp, and more particularly to, a flat fluorescent lamp which can improve discharge efficiency and luminance by increasing a current density per independent discharge channel by forming a plurality of independent meandering discharge channels, lowering a discharge initiation voltage by improving an electrode structure, and removing non-luminescent regions by external electrodes by forming electrode spaces having a larger width than the discharge channels.

### BACKGROUND ART

Among the flat displays, a liquid crystal display (LCD) that is a passive display employs a cold cathode fluorescent lamp (CCFL), an external electrode fluorescent lamp (EEFL), an external internal electrode fluorescent lamp (EIFL), a flat fluorescent lamp (FFL), an electro luminescence (EL) and a light emitting diode (LED) as a light source, namely, a backlight unit. Here, the CCFL is commonly used due to a long lifetime and low power consumption, and thus applied to a thin film transistor liquid crystal display (TFT LCD).

The CCFL has a direct type or an edge type. The direct type CCFL uses a few tens of lamps, which reduces lamp reliability of the LCD. Also, the direct type CCFL is economically disadvantageous due to the high assembly unit cost. The edge type CCFL irradiating a light from the end cannot obtain sufficient luminance for a large-sized LCD panel.

Recently, the FFL has been actively examined as the backlight unit. The FFL has high luminance and lamp reliability, improves optical efficiency and cuts down the unit cost of production of the LCD.

Generally, the FFL is divided into a CCFL type and an EEFL type by the electrode arrangement.

In the CCFL type FFL, all discharge channels are divided by cross walls and extended as one meandering channel. The starting end of the discharge channel faces the terminating end thereof, and a fluorescent film is coated on the long discharge channel.

The CCFL type FFL includes the long discharge channel, and thus requires a high discharge initiation voltage proportional to the length of the discharge channel. That is, the CCFL type FFL needs a few tens kV of high voltage for lighting. Accordingly, an output voltage of an inverter rises, and power loss occurs by electronic wave failure and voltage leakage. When the CCFL type FFL is used as the backlight unit, the LCD is not suitable for home use.

A method for dividing a discharge channel has been suggested to solve the above problems. However, each discharge space cannot be efficiently exhausted, and an inverter must be installed in each discharge channel. As a result, the unit cost of production increases.

On the other hand, the EEFL type FFL performs a discharge operation within a relatively shorter distance than the CCFL type FFL by arranging electrodes outside both ends of a glass substrate including discharge channels. The EEFL type FFL can stably perform the discharge operation even in a low voltage. In addition, the electrodes can be easily installed on the EEFL type FFL.

However, in order to obtain target luminance, the EEFL type FFL using the external electrodes must have a large electrode area to sufficiently flow a current. An increased dead space of the lamp deteriorates the outer appearance of the lamp.

A plurality of discharge channels are formed on the EEFL type FFL in the width direction. Therefore, power consumption increases to obtain an appropriate current density in each discharge channel.

When the sectional area of the discharge channels is reduced to obtain the appropriate current density in the EEFL type FFL, the number of the discharge channels and the width of the cross walls increase. When the number of the discharge channels increases, power consumption is raised, and when the width of the cross walls increases, the umbra by the cross walls is enlarged. The backlight unit is thickened to remove the umbra.

The present inventors made every effort to overcome low efficiency of the surface discharge type FFL, and applied FFL-related technologies for registration, such as ‘Lamp assembly using flat lamp (Korea Laid-Open Patent Application No. 2002-0072260, Sep. 14, 2002)’, ‘Flat lamp and lamp assembly using the same (Korea Laid-Open Patent Application No. 2004-0014037, Feb. 14, 2004)’, ‘Backlight unit using flat lamp (Korea Laid-Open Patent Application No. 2004-0013020, Feb. 11, 2004)’, and ‘Flat lamp and backlight unit using the same (Korea Laid-Open Patent Application No. 2004-0004240, Jan. 13, 2004)’. In addition, the present inventors suggested a method for attaining uniform luminance of the FFL by maximizing optical efficiency and minimizing the non-luminescent regions by improving the structure and arrangement of the electrodes.

At last, the present inventors developed an FFL having a plurality of meandering discharge channels, and also developed an FFL using internal and external electrodes for maximizing efficiency.

One example of the fluorescent lamp using the mixed electrodes has been disclosed in ‘Discharge lamp and back light unit using the same (Korea Patent Registration No. 0392181, Jul. 8, 2003)’. Especially, FIG. 6 shows a CCFL type lamp having mixed electrodes.

Another example of the fluorescent lamp using the mixed electrodes has been disclosed in ‘Mixed discharge type FFL (Korea Patent Registration No. 0399006, Sep. 8, 2003)’. Here, the FFL uses both direct current type and alternating current type electrodes. The direct current discharge type electrodes in which the direct current flows due to metal electrodes exposed to discharge spaces cannot stably control the discharge operation in low luminance, and the alternating current discharge type electrodes having their both ends coated with a dielectric layer cannot attain high luminance due to a low current. The FFL solves the above problems.

However, in the case of the FFL having the direct current type internal electrodes and the alternating current type external electrodes as shown in FIG. 6 of Korea Patent Registration No. 0399006, since the discharge channels divided by the cross walls are connected at both ends, a crosstalk of performing the whole discharge operation in one channel having a relatively low discharge initiation voltage may occur. It is because the discharge operation is frequently performed in the region having the lowest resistance.

That is, the discharge operation is not performed in the whole discharge channels. As a result, there are difficulties in manufacturing the large-sized lamp and improving optical efficiency thereof.

### DISCLOSURE OF THE INVENTION

The present invention is achieved to apply the mixed electrode technology of Korea Patent Registration No. 0392181 to an FFL and solve the problems of Korea Patent Registration No. 0399006.

An object of the present invention is to provide an FFL which can increase luminance and decrease a discharge initiation voltage by improving optical efficiency, by separating one long meandering discharge channel into a plurality of independent meandering discharge channels, disposing electrode spaces in the starting and terminating ends of each discharge channel, and arranging discharge electrodes in the electrode spaces.

Another object of the present invention is to provide an FFL including discharge electrodes having an external electrode structure to stably discharge a plurality of discharge channels by a small number of inverters, and to provide an FFL including discharge electrodes having an internal and external electrode structure to reduce non-luminescent regions of the external electrodes and improve luminescence efficiency.

Yet another object of the present invention is to provide an FFL which can lower a discharge initiation voltage and maximize discharge efficiency, by forming main discharge electrodes and auxiliary electrodes, connecting the auxiliary electrodes to the main discharge electrodes and applies the same voltage, temporarily applying power at the initial stage of the discharge operation and floating the auxiliary electrodes during the discharge operation, or disposing the auxiliary electrodes in the form of floating electrodes.

Yet another object of the present invention is to provide an FFL having special shapes of internal electrodes and internal electrode curved units for easy assembly, lamp reliability and stable operation.

In order to achieve the above-described objects of the invention, there is provided an FFL including: two substrates; a sidewall formed on any one of the two substrates to correspond to the edges of the two substrates, and bonded to the two substrates to form an airtight space for discharge; cross walls formed on at least one surface of the two substrates, for separating the two substrates and forming a plurality of independent meandering discharge channels; and discharge electrodes disposed in electrode regions formed as channels at both sides of the starting and terminating ends of the meandering discharge channels on the sidewall, for discharging the discharge channels in parallel.

The discharge electrodes are external electrodes or mixed electrodes of internal and external electrodes made of a metal. Protruding units are formed on the internal electrodes by bending the plate-shaped metal.

The discharge electrodes further include auxiliary electrodes disposed outside the discharge channels to lower a discharge initiation voltage. The auxiliary electrodes are extended in a continuous line from the discharge electrodes along the discharge channels. The auxiliary electrodes are formed in a discontinuous line along the discharge channels and floated. The auxiliary electrodes are formed on the outside surface of the substrate and made of a transparent conductive material.

The discharge electrodes having different polarities are applied to the electrode regions of both ends of the meandering discharge channels, and the discharge electrodes having the same polarity are disposed in the same direction.

The adjacent meandering discharge channels are symmetrical to each other.

The discharge electrodes having different polarities are applied to the electrode regions of both ends of the meandering discharge channels, the electrode regions connected to the same discharge channel are disposed in the same direction, and the adjacent meandering discharge channels are symmetrical to each other.

The discharge electrodes having different polarities are applied to the electrode regions of both ends of the meandering discharge channels, the electrode regions connected to the same discharge channel are disposed in the same direction, the adjacent meandering discharge channels are symmetrical to each other, and the electrode regions thereof have symmetrical polarities.

The discharge electrodes having different polarities are applied to the electrode regions of both ends of the meandering discharge channels, and the whole electrode regions are disposed in one direction.

Preferably, the curved parts of the meandering discharge channels have the same width as that of the other parts, and the discharge channels have a width of 3 to 15 mm and a height of 2 to 5 mm.

Only the internal electrodes are used in the electrode spaces, and the discharge channels are connected in parallel and driven by connecting special external capacitive elements to the internal electrodes.

The internal electrodes are selectively used in the electrode spaces, protruding units are formed in the internal electrodes, and curved units are formed in the protruding units, so that the protruding units can be positioned at the center portions of the discharge channels.

### BRIEF DESCRIPTION OF THE DRAWINGS

The present invention will become better understood with reference to the accompanying drawings which are given only by way of illustration and thus are not limitative of the present invention, wherein:

FIG. 1 is a disassembly perspective view illustrating an FFL improving discharge efficiency in accordance with the present invention;

FIG. 2 is a perspective view illustrating a rear substrate of FIG. 1;

FIG. 3 is a perspective view illustrating the bottom surface of the rear substrate of FIG. 1;

FIG. 4 is a perspective view illustrating an internal electrode structure in accordance with the present invention;

FIG. 5 is a cross-sectional view illustrating an internal electrode disposed at a discharge channel;

FIGS. 6 to 11 are plane layout views illustrating auxiliary electrode arrangements in accordance with the present invention; and

FIGS. 12 to 16 are plane layout views and perspective views illustrating shapes of discharge channels in accordance with the present invention.

### BEST MODE FOR CARRYING OUT THE INVENTION

A flat fluorescent lamp (FFL) improving discharge efficiency in accordance with the present invention will now be described in detail with reference to the accompanying drawings. In the following description, same drawing reference numerals are used for the same elements even in different drawings.

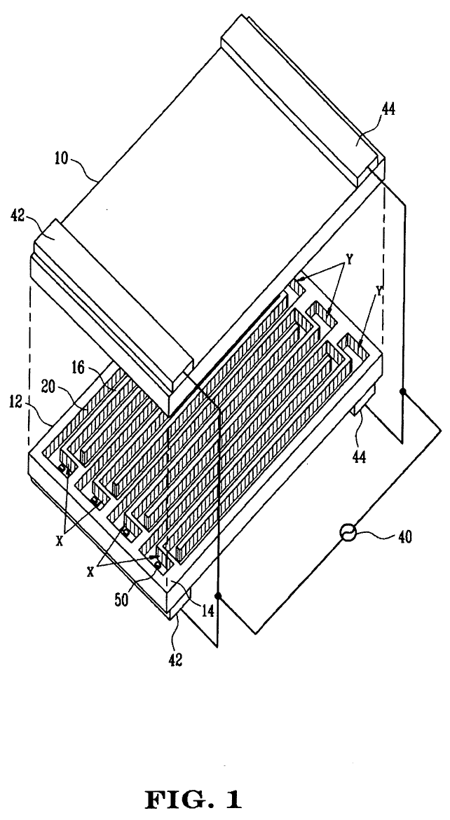

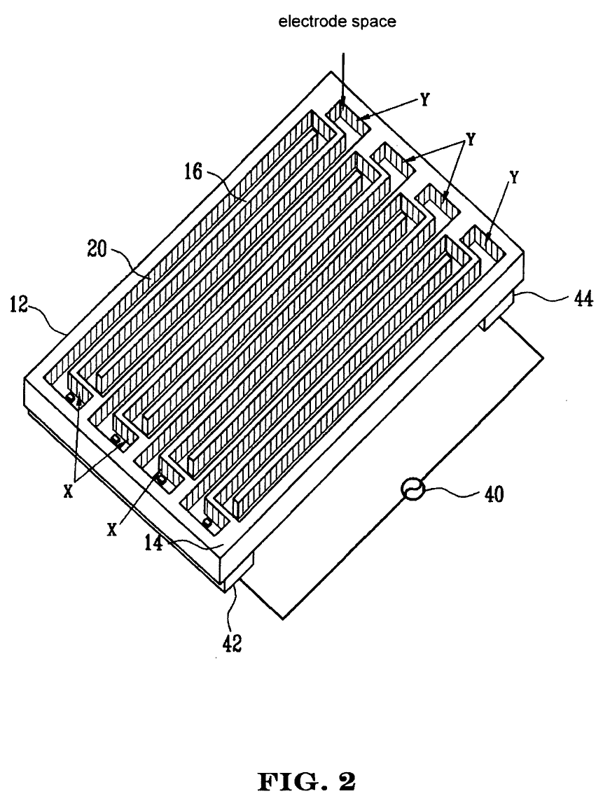

Referring to FIG. 1, in the FFL, two facing substrates, namely, a front substrate 10 and a rear substrate 12 are bonded with a sidewall 14 therebetween. FIG. 2 shows the detailed structure of the rear substrate 12.

The sidewall 14 externally isolates discharge spaces formed between the two substrates 10 and 12. As shown in FIGS. 1 and 2, the sidewall 14 can be incorporated with the rear surface 12, or bonded to the rear substrate 12 by a sealing member (for example, low melting point glass such as frit glass) according to the intention of the manufacturer.

In addition, the sidewall 14 can be separately formed from cross walls 16 discussed later or incorporated with the cross walls 16. Still referring to FIGS. 1 and 2, the sidewall 14 is incorporated with the cross walls 16.

The sidewall 14 formed on the rear substrate 12 can be bonded to the front substrate 10 by a sealing member such as a low melting point glass (for example, frit glass).

The cross walls 16 are formed on the rear substrate 12. For easy explanation, the substrate on which the cross walls 16 are formed is defined as the rear substrate 12, and the other substrate is defined as the front substrate 10, which is not intended to be limiting. That is, symmetrical cross walls can be formed on the front and rear substrates 10 and 12, respectively.

Normally, a reflective layer (not shown) can be coated on the lower portion of the rear substrate 12. The reflective layer is made of white ceramic materials containing Al₂O₃, TiO₂ and WO₃ as major elements. The reflective layer improves luminance by increasing reflectivity of light generated by a fluorescent material (not shown) coated in discharge channels 20.

The cross walls 16 can be formed by processing the rear substrate 12 by a sand blasting process, a laser process or a grinding process. In addition, the cross walls 16 can be formed by heating and softening the rear substrate 12 and pressing or vacuum-adsorbing the resulting structure, or by cutting a flat plate glass by an appropriate height, coating a sealing frit thereon, and heating and adhering the resulting structure. Differently, the cross walls 16 can be formed by adhering an extruded or pressed glass or ceramic material.

The sections of the cross walls 16 are formed in a rectangular shape, which is not intended to be limiting. The sections of the cross walls 16 can be formed in a trapezoidal or hemispherical shape according to the intention of the manufacturer. That is, the cross walls 16 can be formed in various shapes in consideration of the manufacturing process, the manufacturing convenience and the discharge phenomenon.

As described above, the sidewall 14 and the cross walls 16 are formed on the rear substrate 12, and the discharge channels 20 are formed in the spaces between the sidewall 14 and the cross walls 16.

The discharge channels 20 are formed in a meandering shape by connecting the channels long in the width direction by the channels short in the length direction. In detail, the three channels long in the width direction are connected by the channels short in the length direction, to form a ‘ [symbol] ’ shape. One-side ends of the meandering discharge channels 20 are connected to and extended by length direction channels additionally formed on the sidewall 14, and the other-side ends of the meandering discharge channels 20 are connected to and extended by other additional length direction channels. Here, the ends of the discharge channels 20 are formed in the opposite directions, and the channels additionally extended from the ends of the discharge channels 20 in the length direction are used as electrode spaces.

In detail, external electrodes 42 and 44 that are transparent or metal electrodes are extended in the length direction in the channel regions used as the electrode spaces outside the front substrate 10 and the rear substrate 12. The external electrodes 42 and 44 having the same polarity are commonly connected to each other, and the external electrodes 42 and 44 having different polarities receive power from a power supply unit 40.

On the other hand, the top surfaces of the cross walls 16 are closely adhered to the front substrate 10, for isolating the adjacent discharge channels 20.

In the case that the discharge channels 20 have a large sectional area, mis-discharge by minute gaps of the top surfaces of the cross walls 16 can be prevented by adhering the top surfaces of the cross walls 16 to the front substrate 10.

However, when the discharge channels 20 have a small sectional area, it is relatively difficult to perform the discharge operation through the narrow and long discharge channels 20. Therefore, a discharge crosstalk may occur by the minute gaps of the top surfaces of the cross walls 16.

In this case, the crosstalk can be prevented by increasing the width of the cross walls 16. However, when the top surfaces of the cross walls 16 have a large width, the non-luminescent regions of the lamp increase during the discharge operation, thereby generating the umbra. The distance between the lamp and the diffusion material installed on the whole surface of the lamp must be additionally increased to remove the umbra. On the other hand, the discharge crosstalk by the top surfaces of the cross walls 16 can be completely prevented by applying a sealing material (frit glass) to the top surfaces of the cross walls 16, and heating and adhering the cross walls 16 and the front substrate 10.

As mentioned above, the discharge channels 20 that are the spaces between the cross walls 16 are individually formed in a meandering shape (like snake's movement), by connecting a plurality of discharge lines in series.

As compared with the general long meandering discharge channel, the discharge channel 20 of the present invention is divided into a plurality of short meandering shapes, thereby efficiently controlling an excessive discharge voltage by channel length variations.

For example, when the meandering discharge channel is formed by connecting thirty straight lines in a zigzag shape in the width direction, the distance between both end electrodes is longer than the width direction length by thirty times. When the ten short meandering discharge channels are formed by connecting every three straight line in series, the distance between both end electrodes is longer than the width direction length by three times. Accordingly, the discharge initiation voltage proportional to the distance between the electrodes can be reduced to 1/10.

The electrode spaces corresponding to the starting and terminating ends of the discharge channels 20 are formed on the sidewall 14 as channels, and the external electrodes 42 and 44 are disposed outside the electrode spaces.

The current is constantly restricted in the discharge channels 20 near the external electrodes 42 and 44 due to the dielectric barriers by the substrates 10 and 12. Thus, the current is not concentrated on a specific channel. That is, the plurality of channels can be evenly discharged on the whole area by using one inverter (corresponding to the power supply unit 40 of FIG. 1). The luminescence can be stabilized and the unit cost of the circuit can be cut down.

The width of the electrode spaces is larger than that of the discharge channels 20, and thus the length of the electrode spaces is relatively reduced in the same area. Therefore, the non-luminescent regions decrease.

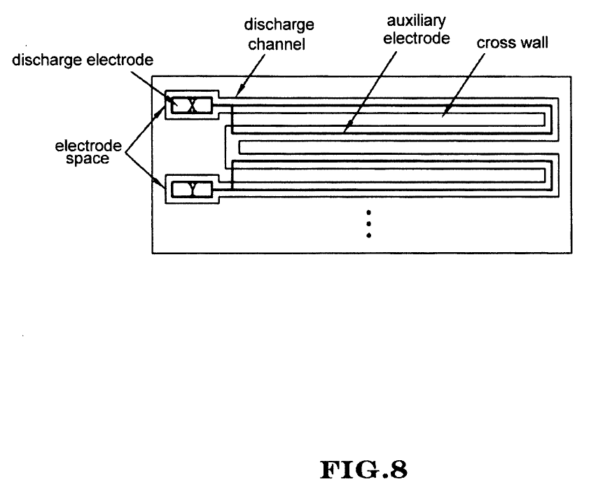

As illustrated in FIG. 8, internal electrodes 30 can be formed in the electrode spaces with the external electrodes 44. Here, the discharge initiation voltage is lowered and discharge efficiency is improved due to electron discharge effects of the metal electrodes.

In the case of the general dielectric barrier discharge operation using the external electrodes, the area of the electrodes surrounding the discharge spaces is very important to control the discharge current. When the discharge channel is narrowed, the area of the electrodes is reduced not to obtain an appropriate current. As a result, a target current density value is not obtained, to reduce luminescence efficiency.

In accordance with the present invention, when the internal electrodes and the external electrodes are used together, a double capacitance is obtained by the external electrodes having the same area, and thus a double current flows through the external electrodes, thereby increasing luminance of the lamp. In the case that the same amount of current flows, the area of the external electrodes can be reduced into a half. As a result, the mixed electrodes of the fluorescent lamp can improve luminescence efficiency and reduce the non-luminescent regions.

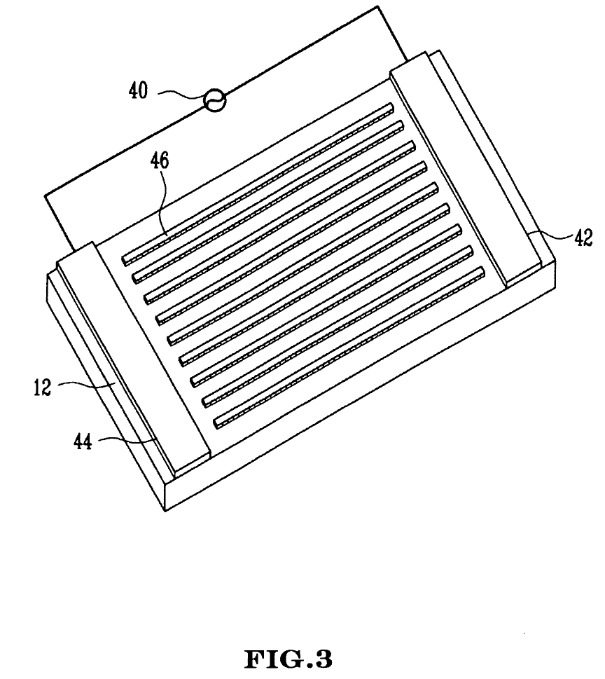

FIG. 3 shows the bottom surface of the rear substrate 12. The external electrodes 42 and 44 are formed in the length direction to correspond to the electrode spaces. Auxiliary electrodes 46 are formed in a meandering shape between the external electrodes 42 and 44 to correspond to the regions of the meandering discharge channels 20. The auxiliary electrodes 46 are floated long and narrow with hexahedral sections.

Otherwise, only the internal electrodes 30 are used in the electrode spaces, and the discharge channels 20 are connected in parallel and driven by connecting special capacitive elements outside the fluorescent lamp.

Since the capacitive elements restrict the current of each discharge channel 20, a discharge concentration phenomenon discharging only a few channels can be overcome, and the lamp can be stably driven in parallel. Although a number of components composing the internal electrodes 30 and the capacitors increases, it is still advantageous to improve discharge efficiency by the internal electrodes 30.

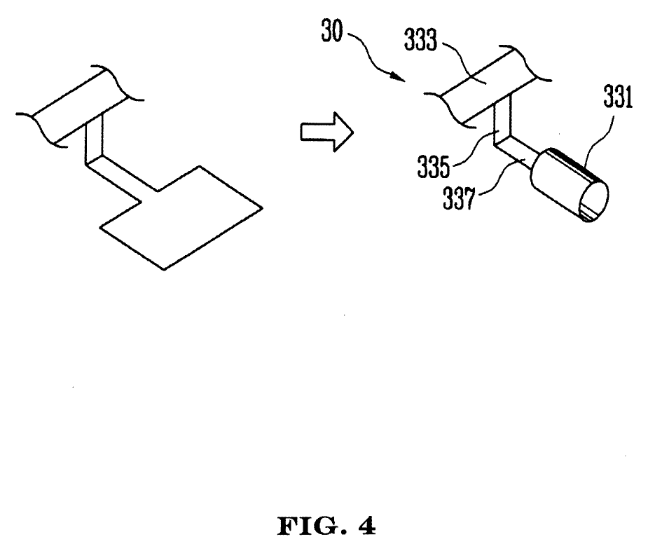

As shown in FIG. 4, when protruding units 337 are formed in the internal electrodes 30 and extended into the fluorescent lamp, the current is induced to flow through the protruding units 337. Therefore, the discharge operation can be more stabilized.

When the protruding units 337 are formed in the internal electrodes 30, curved units 335 are formed on plate-shaped electrodes 333, so that the protruding units 337 can be positioned at the center portions of the sections of the discharge channels 20. As a result, reliability of the FFL can be improved by minimizing thermal impacts of the substrates by heat generation of the electrodes.

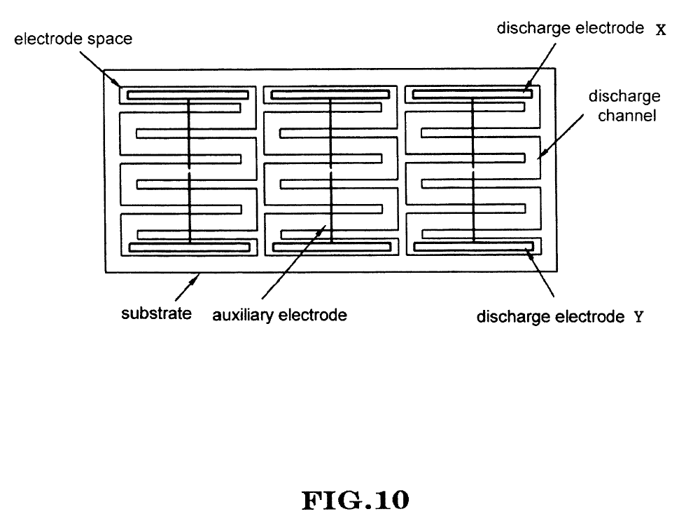

Preferably, the FFL is efficiently vacuum-sealed up by relatively narrowing the width of the plate-shaped electrodes 333 disposed on the sidewalls of the edges thereof, or externally extending the plate-shaped electrodes 333 by using connection lines 339 as shown in FIG. 10.

The protruding units 337 can be pressed and curved in a cylindrical shape 331. Because the electrodes are mass-produced by forming the plate-shaped materials by a consecutive process using a mold, the unit cost of production of the FFL can be remarkably cut down.

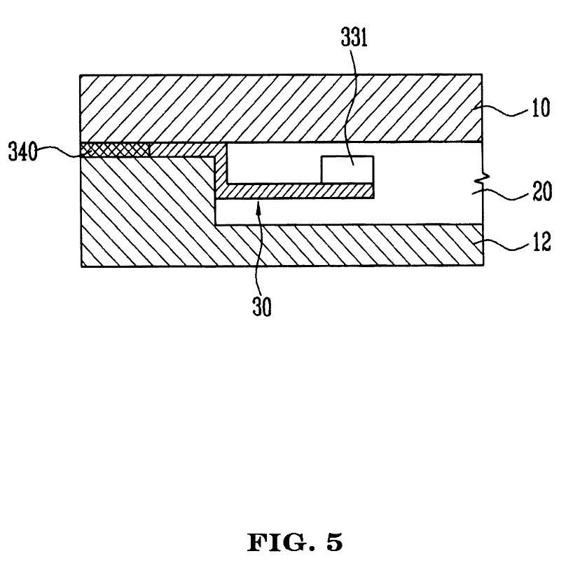

As shown in FIG. 5, the cylindrical parts 331 of the protruding units 337 are positioned at the center portions of the sections of the discharge channels 20 by the curved units 335 of the electrodes 30. When the internal electrodes 30 are inserted between the substrates 10 and 12, they can be positioned at the center portions of the sections of the discharge channels 20. Accordingly, in the normal discharge operation of the product, the substrates 10 and 12 are not damaged by the heat generated from the electrodes 30. In FIG. 5, reference numeral 340 denotes the frit glass for adhering the front substrate 10 to the rear substrate 12.

The auxiliary electrodes 46 are formed outside the discharge channels 20 in addition to the main electrodes such as the external electrodes 42 and 44 and the internal electrodes 30, for overcoming increase of the discharge initiation voltage by the lengthened discharge channels 20. When the discharge initiation voltage increases by the lengthened discharge channels 20, the driving voltage rises. The auxiliary electrodes 46 solve the problem by reducing the distance between the discharge electrodes.

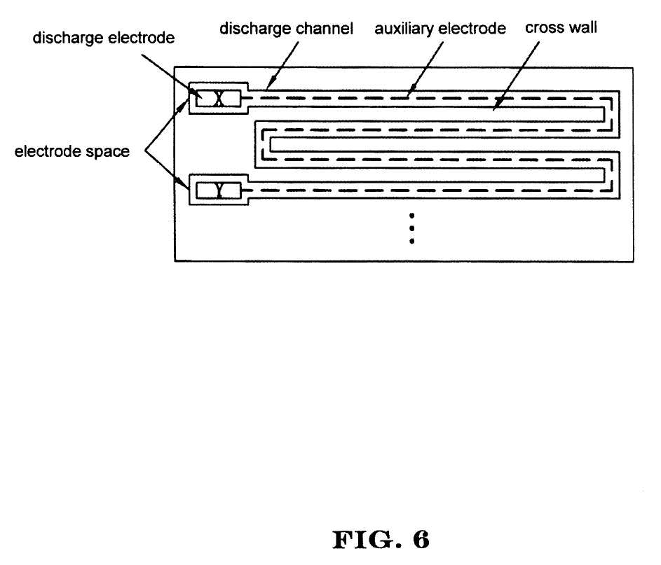

As illustrated in FIGS. 6 to 9, the auxiliary electrodes 46 can be modified in various shapes. The examples of the auxiliary electrodes 46 can be applied to the discharge channels 20 of FIGS. 1 and 3 and other discharge channels.

In FIGS. 6 to 9, the discharge electrodes X and Y are disposed in the same direction. The meandering discharge channels for connecting the discharge electrodes X and Y include four length direction channels, respectively. Curved units for connecting the length direction channels are formed in the opposite sides to the discharge electrodes X and Y.

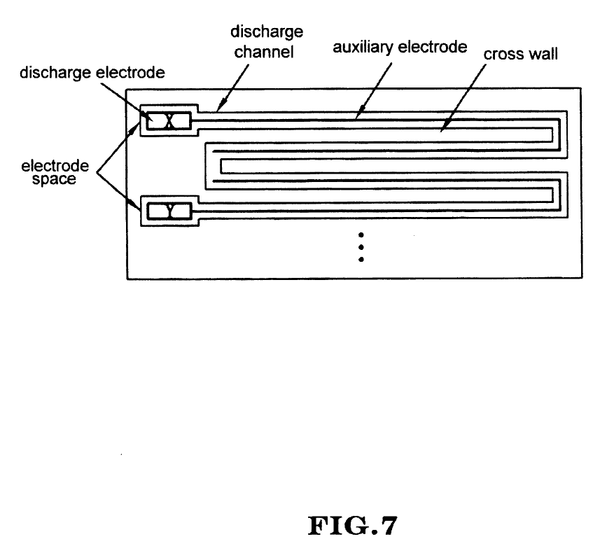

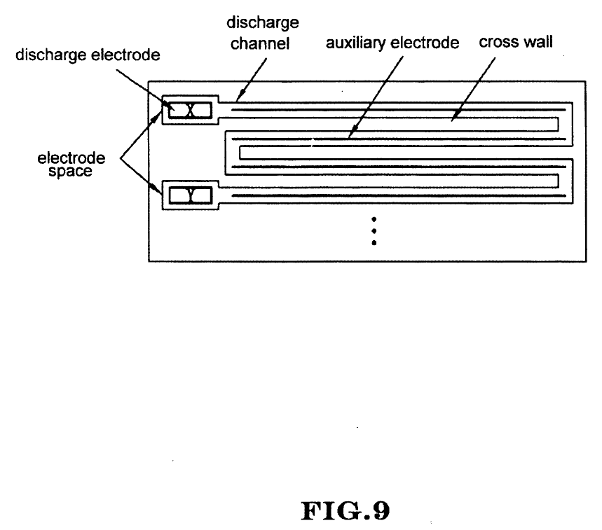

In the examples of FIGS. 6 to 9, the channels composing the electrode spaces are disposed in the same direction, and the auxiliary electrodes are formed in the meandering discharge channels having the curved parts. In the example of FIG. 6, the auxiliary electrodes are floated in a dotted line along the discharge channels between the two electrode spaces having different polarities. In the example of FIG. 7, the auxiliary electrodes are extended from each electrode along the discharge channels between the two electrode spaces having different polarities, and provided with the same potentials as those of the electrodes. In the example of FIG. 8, the auxiliary electrodes are extended along the discharge channels between the two electrode spaces having different polarities, form closed loops at the middle portions of the discharge channels, and are provided with the same potentials as those of the electrodes. In the example of FIG. 9, the auxiliary electrodes are disposed in a solid line in each line of the discharge channels, and floated respectively.

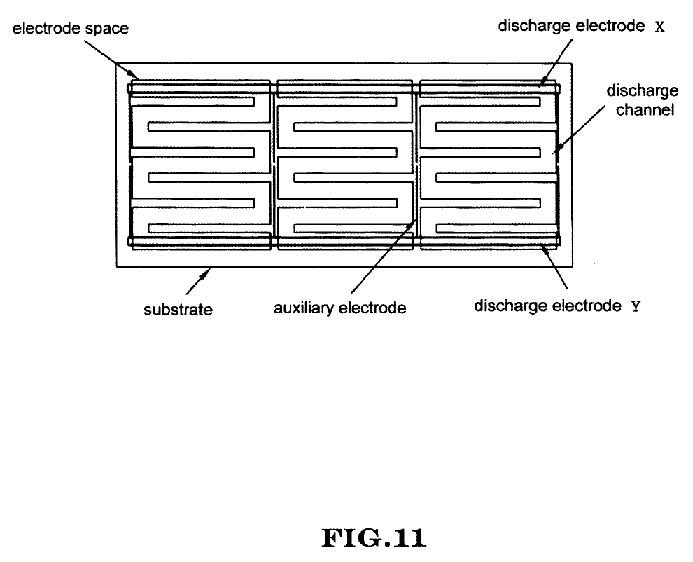

FIGS. 10 and 11 show one example of the auxiliary electrode arrangement in the lamp having the discharge channel structure of arranging the length direction meandering discharge channels in the width direction.

Referring to FIG. 10, the discharge electrodes having X and Y polarities are disposed at both ends of the upper and lower portions of the discharge channels. The auxiliary electrodes are extended in a solid line from each electrode to the center portion of the lamp to cross the meandering discharge channels.

As depicted in FIG. 11, the discharge electrodes having X and Y polarities are disposed at both ends of the upper and lower portions of the discharge channels. The auxiliary electrodes are extended in a solid line from each electrode to the center portion of the lamp, and disposed at the top ends of the length direction cross walls for isolating the discharge channels.

As described above, when the auxiliary electrodes are embodied in various forms as shown in FIGS. 6 and 11, the preliminary discharge operation occurs between the auxiliary electrodes and the internal electrodes, and then the whole discharge operation occurs between the main electrodes. Accordingly, the auxiliary electrodes obtain voltage drop effects and improve discharge efficiency of the main electrodes.

When the width of the auxiliary electrodes is too large, the discharge current of the auxiliary electrodes increases. Therefore, power consumption increases and luminance of the FFL decreases. Moreover, when the discharge operation is mostly performed between the main electrodes, a relatively long plasma column is formed to improve discharge efficiency. If the auxiliary electrodes consume much current, discharge efficiency is reduced.

Conversely, when the width of the auxiliary electrodes is too small, voltage application effects decrease. Preferably, the auxiliary electrodes are formed in an appropriate width.

Still referring to FIGS. 6 to 11, the auxiliary electrodes are extended in a continuous line from the main discharge electrodes along the discharge spaces, disposed in a discontinuous line and floated, disposed in a solid line separately from the main discharge electrodes and floated, or provided with power in a predetermined period of the discharge operation and re-floated.

Preferably, when the auxiliary electrodes are installed outside the front substrate, a transparent conductive material such as an ITO is used to prevent reduction of optical transmissivity and loss of luminance.

In the manufacturing process of the lamp, the external electrodes are formed by printing, drying and baking a metallic paste material or directly adhering a metallic tape material.

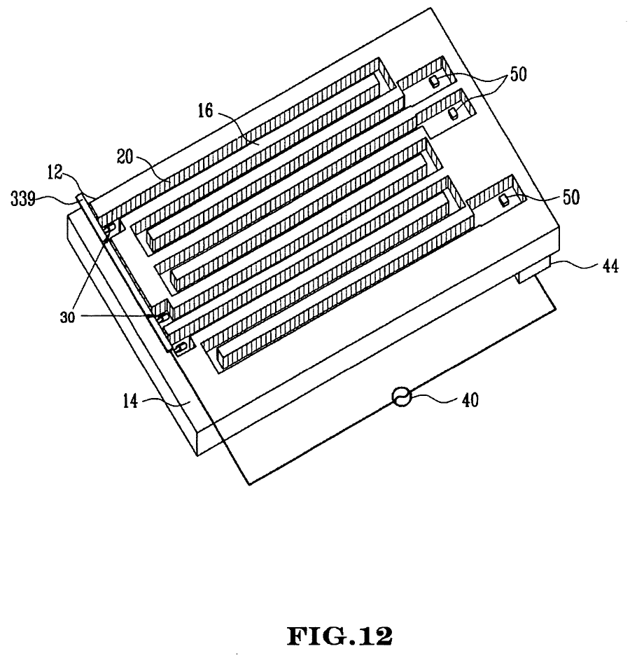

As shown in FIG. 12, the internal electrodes 30 are mounted inside the lamp, and the front substrate 10 and the sidewall 14 are adhered by the low melting point glass (for example, frit glass) that is a sealing member. The lamp is vacuumed by an exhausting process using an exhaust tube (not shown), and filled with a discharge gas (rare gas such as Ar, Ne and Xe, or Hg). Manufacturing of the lamp is finished by fusing the exhaust tube.

Preferably, the discharge channels 20 between the cross walls 16 have a width of 3 to 15 mm and a height of 2 to 5 mm.

When the sections of the discharge channels 20 are too narrow, the driving voltage is raised and the discharge operation is destabilized. When the sections of the discharge channels 20 are too wide, the driving voltage is reduced, but the discharge plasma is partially formed in the sections of the channels 20. Therefore, fluorescent luminescence does not occur in the whole discharge channels 20, thereby partially forming dark regions.

Preferably, the channel width of the curved parts (length direction) for connecting the discharge lines of the discharge channels 20 must be identical to the width direction channel width because the discharge operation is not efficiently performed in the narrow regions.

A fluorescent layer (not shown) is coated on the cross walls 16 and the bottom surface of the rear substrate 12. That is, a white fluorescent material is made by mixing green, blue and red fluorescent materials on the basis of chromaticity, mixed with an organic resin, coated at a predetermined thickness, and baked.

On the other hand, the discharge channels that are major elements of the present invention can be embodied in various forms.

The meandering discharge channels can be formed in a ‘ [symbol] ’ shape by connecting two lines or in a ‘ [symbol] ’ shape by connecting three lines. Also, the meandering discharge channels can be formed in various shapes by connecting more lines.

When both polarities of the potentials applied to the discharge electrodes are defined as X and Y, X and Y can be alternately or selectively arranged on the discharge channels, such as X, Y, X, Y, X, Y or X, Y, Y, X, X, Y, Y, X.

When the curved units for forming the meandering discharge channels are provided in an even number, that is, when each discharge channel is formed by connecting an odd number of lines, the starting and terminating ends of the discharge channels can be separately disposed at both ends of the right and left sides of the substrate.

For example, when ten ‘ [symbol] ’-shaped discharge channels very long in the width direction are formed in the length direction by connecting every three line, the starting points of the first to 10^{th} discharge channels are disposed at the left side of the substrate, and the terminating points thereof are disposed at the right side of the substrate. When the electrodes are arranged, the starting points positioned at the left side of the substrate are used as X electrode spaces, and the terminating points positioned at the right side of the substrate are used as Y electrode spaces. A power line can be easily connected afterwards. As a result, when each of the discharge channels is formed by connecting an odd number of lines, the electrodes can be easily arranged.

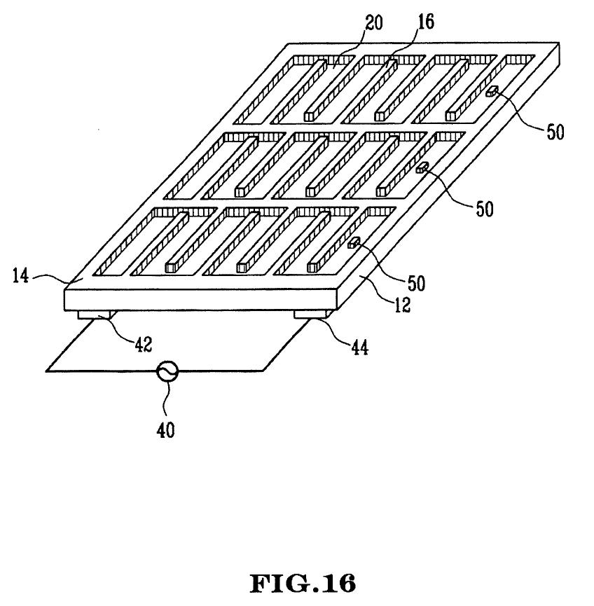

As illustrated in FIG. 16, when the meandering discharge channels formed in the length direction by connecting the discharge lines having a relatively short length are connected in parallel in the width direction, X and Y polarities can be disposed at both ends of the upper and lower portions of the discharge channels. That is, the electrodes can be efficiently arranged regardless of the number of the channels.

The discharge channels can be repeatedly formed in a ‘ [symbol] ’ shape as shown in FIG. 1, and can also be formed in various shapes as shown in FIGS. 12 to 16.

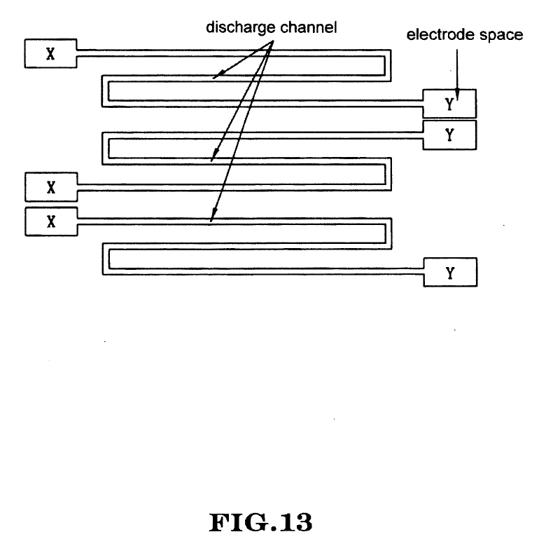

In the example of FIG. 12, the channels for forming the electrode spaces are connected to both ends of the right and left sides of the ‘ [symbol] ’-shaped discharge channels. The channels connected to one direction ends of the discharge channels are used as X electrode spaces, and the channels connected to the other direction ends of the discharge channels are used as Y electrode spaces. The internal electrodes 30 can be disposed in X electrode spaces. FIG. 13 is a plane layout view illustrating the discharge channels of FIG. 12.

In FIGS. 12 and 13, the electrode spaces having the same polarity are formed in the same direction.

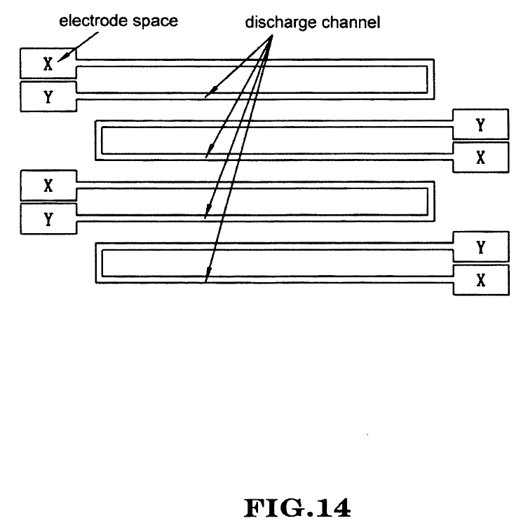

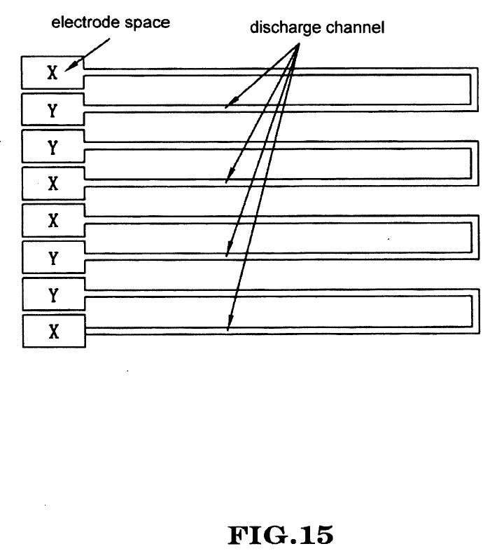

Differently, in FIGS. 14 and 15, the electrode spaces having different polarities are disposed in one direction. The meandering discharge channels are formed in a ‘ [symbol] ’ shape.

Still referring to FIGS. 14 and 15, the electrode spaces are disposed in one direction in the order of X, Y, X, Y, and in the other direction in the order of Y, X, Y, X. Differently, referring to FIG. 13, the electrode spaces are disposed in the order of X, Y, Y, X, X, Y.

On the other hand, as shown in FIG. 16, the discharge channels 20 can be formed by repeatedly arranging the length direction channels, and forming the curved units at the length direction ends of the channels. The channels extended from the ends of the discharge channels 20 and disposed in the length direction are used as the electrode spaces. The discharge electrodes can be formed in the electrode spaces.

When the FFL having the discharge channel and electrode structure described above receives power from the inverter connected to the electrodes through a conductive line, the preliminary or auxiliary discharge operation occurs in the discharge spaces between the auxiliary electrodes, thereby generating ions or electrons. Thereafter, the whole discharge operation is performed in the effective luminescent regions between the main discharge electrodes by the ions or electric charges.

In the discharge operation, when Hg is used as an excitation source, 254 nm of ultraviolet rays are generated, and when Xe gas is used as the excitation source, 147 nm and 173 nm of vacuum ultraviolet rays are generated. The vacuum ultraviolet rays reach the fluorescent layer coated on the surfaces of the front and rear substrates in the discharge channels.

The fluorescent layer is excited by the vacuum ultraviolet rays and transited to the bottom state, to generate visible rays. The visible rays are dispersed by passing through the front substrate and the diffusion material positioned on the top surface of the lamp. When the visible rays further pass through the stacked prism, directive lights are externally emitted.

As discussed earlier, in accordance with the present invention, the FFL uses the plurality of independent meandering discharge channels. That is, the discharge channels shorter than the conventional discharge channel are arranged in a multiple number. Discharge efficiency and luminance can be improved by increasing the current density per discharge channel. Thus, the large-sized stabilized FFL can be manufactured.

Moreover, discharge efficiency by the internal electrodes can be maximized by using the internal and external electrodes together, which results in low power consumption.

When the internal electrodes are inserted between the substrates, the internal electrodes can be easily positioned at the center portions of the sections of the channels. Therefore, the panels are not thermally damaged by the electrodes.

In addition, the discharge initiation voltage can be lowered by using the auxiliary electrodes extended and floated in a continuous or discontinuous line. It is thus possible to implement an appropriate structure for the FFL of the large-sized flat display.

The discharge channels and the auxiliary electrodes have been explained in relation to the FFL, but other publicly-known technologies have been omitted. It is obvious that such technologies can be easily inferred by those skilled in the art to which the present invention pertains.

Although the FFL having the special shape and structure has been described with reference to the accompanying drawings, various changes, modifications and combinations can be made on the characteristics of the present invention relating to the discharge channels, the mixed electrodes, the auxiliary electrodes and the internal electrodes by those skilled in the art. It must be construed that such changes, modifications and combinations belong to the protection scope of the present invention.

What is claimed is:

1. A flat fluorescent lamp, comprising:
two substrates;
a sidewall formed on any one of the two substrates to correspond to the edges of the two substrates, and bonded to the two substrates to form an airtight space for discharge;
cross walls formed on at least one surface of the two substrates, for separating the two substrates and forming a plurality of independent meandering discharge channels; and
discharge electrodes disposed in electrode regions formed as channels at both sides of the starting and terminating ends of the meandering discharge channels on the sidewall, for discharging the discharge channels in parallel.

2. The flat fluorescent lamp of claim 1, wherein the discharge electrodes are external electrodes.

3. The flat fluorescent lamp of claim 1, wherein the discharge electrodes are internal and external electrodes made of a metal.

4. The flat fluorescent lamp of claim 1, wherein the discharge electrodes further comprise auxiliary electrodes disposed outside the discharge channels to lower a discharge initiation voltage.

5. The flat fluorescent lamp of claim 2, wherein the discharge electrodes further comprise auxiliary electrodes disposed outside the discharge channels to lower a discharge initiation voltage.

6. The flat fluorescent lamp of claim 3, wherein the discharge electrodes further comprise auxiliary electrodes disposed outside the discharge channels to lower a discharge initiation voltage.

7. The flat fluorescent lamp of claim 3, wherein protruding units are formed on the internal electrodes by bending the plate-shaped metal.

8. The flat fluorescent lamp of claim 7, wherein the auxiliary electrodes are extended in a continuous line from the discharge electrodes along or across the discharge channels.

9. The flat fluorescent lamp of claim 7, wherein the auxiliary electrodes are formed in a discontinuous line along or across the discharge channels and floated.

10. The flat fluorescent lamp of claim 7, wherein the auxiliary electrodes are formed on the outside surface of the substrate and made of a transparent conductive material.

11. The flat fluorescent lamp of claim 1, wherein the discharge electrodes having different polarities are applied to the electrode regions of both ends of the meandering discharge channels, and the discharge electrodes having the same polarity are disposed in the same direction.

12. The flat fluorescent lamp of claim 11, wherein the adjacent meandering discharge channels are symmetrical to each other.

13. The flat fluorescent lamp of claim 1, wherein the discharge electrodes having different polarities are applied to the electrode regions of both ends of the meandering discharge channels, the electrode regions connected to the same discharge channel are disposed in the same direction, the adjacent meandering discharge channels are symmetrical to each other, and the electrode regions thereof have symmetrical polarities.

14. The flat fluorescent lamp of claim 1, wherein the discharge electrodes having different polarities are applied to the electrode regions of both ends of the meandering discharge channels, and the whole electrode regions are disposed in one direction.

15. The flat fluorescent lamp of claim 1, wherein only the internal electrodes are used in the electrode spaces, and the discharge channels are connected in parallel and driven by connecting special external capacitive elements to the internal electrodes.

16. The flat fluorescent lamp of claim 1, wherein the internal electrodes are selectively used in the electrode spaces, and protruding units are formed in the internal electrodes.

17. The flat fluorescent lamp of claim 16, wherein curved units are formed in the protruding units, so that the protruding units can be positioned at the center portions of the discharge channels.

18. The flat fluorescent lamp of claim 16, wherein the ends of the protruding units are formed in a cylindrical shape.

19. The flat fluorescent lamp of claim 17, wherein the ends of the protruding units are formed in a cylindrical shape.

20. The flat fluorescent lamp of claim 1, wherein the independent meandering discharge channel is formed by arranging a plurality of discharge spaces between the electrode spaces at both ends in parallel in the orthogonal direction and alternately connecting a plurality of short discharge channels formed in parallel to the discharge electrodes, and disposed in parallel in a multiple number.
